(19) United States
(12) Patent Application Publication
(10) Pub. No.: US 2015/0235238 A1
(43) Pub. Date: Aug. 20, 2015

(54) PREDICTING ACTIVITY BASED ON ANALYSIS OF MULTIPLE DATA SOURCES

(71) Applicant: International Business Machines Corporation, Armonk, NY (US)

(72) Inventors: Kyle R. Babinowich, New York, NY (US); Swati M. Chhatwal, Edison, NJ (US); Sailee S. Latkar, Secaucus, NJ (US)

(73) Assignee: International Business Machines Corporation, Armonk, NY (US)

(21) Appl. No.: 14/181,341

(22) Filed: Feb. 14, 2014

(51) Int. Cl. G06Q 30/02

(52) U.S. Cl. CPC G06Q 30/0202; G06Q 30/0204

(57) ABSTRACT

In a method for determining consumer activity, a computer retrieves consumer activity data for a consumer from each of a transactional data, demographic data, and social media data source. The computer determines categories, based, at least in part, on the consumer activity data, ranks the categories for the consumer, which represents consumer activity in each category in each of the three data sources, and assigns a weight to each of the three data sources. The computer calculates, based, at least in part, on the assigned weight and the consumer activity data for each of the three data sources, a score for each category in each of the three data sources for the consumer. The computer adds the scores and ranks each category for the consumer, which represents the consumer activity in each of the categories.

### FIELD OF THE INVENTION

The present invention relates generally to the field of predictive analysis, and more particularly to predicting consumer activity based on analysis of multiple data sources.

### BACKGROUND OF THE INVENTION

The proliferation of the Internet has made the modern consumer more informed and thus more empowered than ever by providing the ability to easily compare substitute products and services for individually optimized decision making. Newly armed with this information found online, consumers can select products and services based on their own dynamic utility curve to maximize personal value. A credit card reward program is an example of an area where consumers research different products to find a best fit for their individual utility. Due to this extremely competitive environment and changing spending habits, companies struggle to use the reward programs to attract new consumers and to retain consumer satisfaction.

Companies often use mass advertising to promote various services and programs to individuals via television and other media. Companies can use demographic data to offer different types of programs to different demographics (e.g., reach consumers via mail with card offers based on credit scores). A drawback to these methods is that the companies are forcing consumers to match with existing product offerings. Additionally, there is no dynamic element involved in the match, which may capture a change in a consumer's spending habits, resulting in a consumer matched rewards program that no longer suits their lifestyle. Finally, companies are risking losing their customer by mismatching individuals to services or programs due to sourcing the data unilaterally based on the demographic profile.

### SUMMARY

Embodiments of the present invention are directed to a method, computer program product, and computer system for determining consumer spending behavior. An embodiment includes a computer retrieving consumer activity data for a consumer from three data sources for the consumer, the three data sources including transactional data, demographic data, and social media data. The computer determines, for each of the three data sources, a plurality of categories, based, at least in part, on the consumer activity data, wherein a category is a designation of a merchant of a type of good or service provided by the merchant. The computer ranks the plurality of categories within each of the three data sources for the consumer, the ranking representing consumer activity in each category in each of the three data sources and assigns a weight to each of the three data sources for the consumer, the weight indicating a level of accuracy of the consumer activity data in each of the three data sources for the consumer as compared to the consumer activity data in the other data sources. The computer calculates, based, at least in part, on the assigned weight and the consumer activity data for each of the three data sources, a score for each of the plurality of categories in each of the three data sources for the consumer. The computer adds the scores for each of the plurality of categories in each of the three data sources for the consumer and ranks the plurality of categories for the consumer, the ranking representing the consumer activity in each of the plurality of categories.

### BRIEF DESCRIPTION OF THE SEVERAL VIEWS OF THE DRAWINGS

FIG. 1 is a functional block diagram illustrating a distributed data processing environment, according to an embodiment of the present invention.

FIG. 2 is a flowchart depicting operational steps of a data analysis program, for analyzing various data sources to determine consumer activity, according to an embodiment of the present invention.

FIG. 3 illustrates an exemplary flow diagram of the operational steps of the data analysis program of FIG. 2 using retrieved data, according to an exemplary embodiment of the present invention.

FIG. 4 illustrates an exemplary manner in which results of operation of the data analysis program of FIG. 2 can be used to generate a customized rewards program for a consumer, according to an embodiment of the present invention.

FIG. 5 depicts a block diagram of components of a data processing system, such as the server computing device of FIG. 1, according to an embodiment of the present invention.

### DETAILED DESCRIPTION

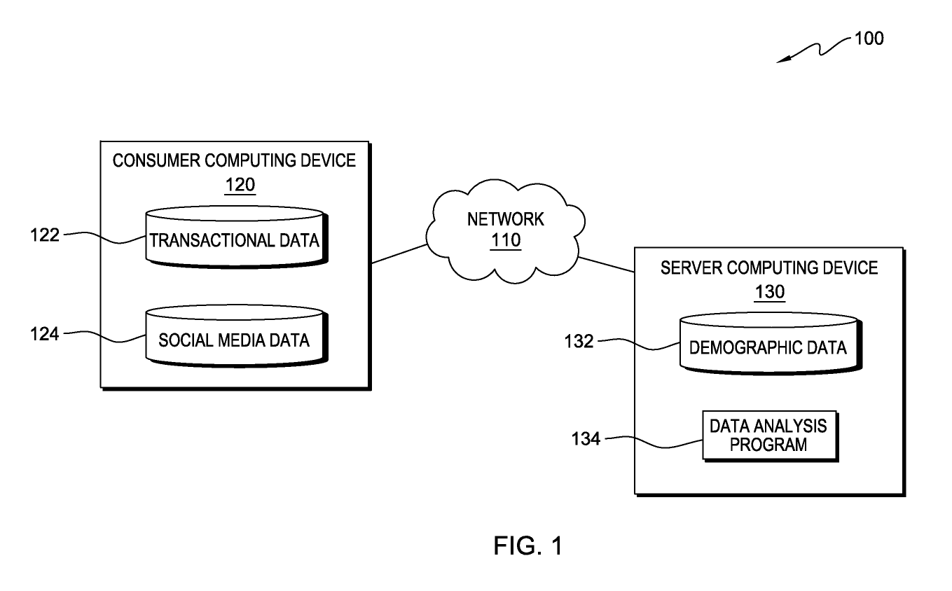

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes consumer computing device 120 and server computing device 130, all interconnected via network 110. Network 110 can be, for example, a local area network (LAN), a wide area network (WAN), such as the Internet, or a combination of the two, and can include wired, wireless, or fiber optic connections. In general, network 110 can be any combination of connections and protocols that will support communications between consumer computing device 120 and server computing device 130.

Consumer computing device 120 may be a desktop computer, a laptop computer, a tablet computer, a specialized computer server, a personal computer (PC), a personal digital assistant (PDA), a smart phone, or any programmable electronic device capable of communicating with server computing device 130 via network 110, and with various components and devices within distributed data processing environment 100. In general, consumer computing device 120 represents any programmable electronic device or combination of programmable electronic devices capable of executing machine-readable program instructions and communicating with other computing devices via a network, such as network 110.

Consumer computing device 120 includes transactional data 122 and social media data 124. Transactional data is historical activity information for a consumer collected from a consumer's currently used credit cards and bank accounts. A consumer's transaction data can provide an accurate and personal source of information about the consumer's historical spending habits and actual transactions. In an embodiment, transactional data 122 stores transactional data for a consumer, for example, a consumer operating consumer computing device 120, for a time period of six months. In various other embodiments, the time period can be quarterly, monthly, or yearly. In other embodiments, the transactional data stored in transactional data 122 can be obtained from loyalty cards, membership rewards, including rewards points earned or redeemed, or other sources of transactional data. Transactional data 122 stores information that can encapsulate an individual's purchase history and historical spending activity, helping to capture changing consumer preferences as they occur, for example, a consumer may make large home improvement purchases in the spring each year, or purchase baseball-related items during baseball season.

Social media data 124 stores real-time activity information for a consumer operating consumer computing device 120, for example, location based data such as location “check in” information on a social network program. A data analysis program, such as data analysis program 134 on server computing device 130, can use location based data, including permanent location or temporary check-ins, to analyze and predict spending patterns. For example, data analysis program 134 can analyze how much and how often a consumer spends money at a certain restaurant in a certain city or the frequency a consumer visits a gas station for fuel purchases. Social media data 124 can also include a consumer's endorsements, postings, reviews, comments, likes, and other communication via a social network that provides information on a consumer's activity. Social media data 124 can capture information that may not be apparent from transactional data alone, for example, a consumer's engagement or planned travel. Additionally, in various embodiments, social media data 124 can capture location based trends in consumption, including new or popular items, restaurants, and services.

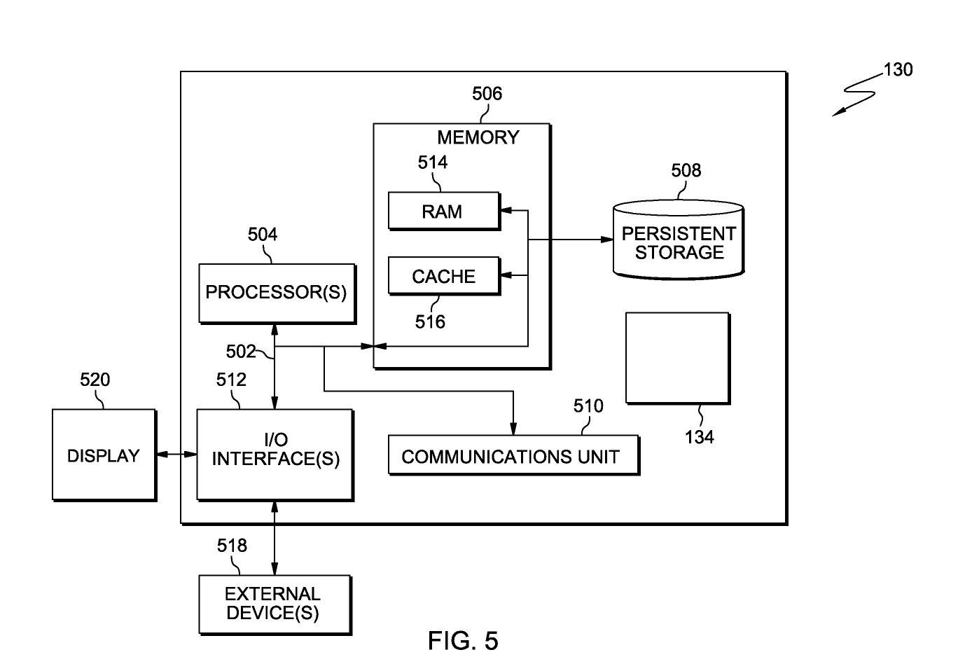

Server computing device 130 may be a management server, a web server, or any other electronic device or computing system capable of receiving and sending data. In other embodiments, server computing device 130 may represent a server computing system utilizing multiple computers as a server system, such as in a cloud computing environment. In another embodiment, server computing device 130 may be a laptop computer, a tablet computer, netbook computer, a personal computer (PC), a desktop computer, a personal digital assistant (PDA), a smart phone, or any programmable electronic device capable of communicating with consumer computing device 120 via network 110. In another embodiment, server computing device 130 represents a computing system utilizing clustered computers and components to act as a single pool of seamless resources. Server computing device 130 may include internal and external hardware components, as depicted and described with reference to FIG. 5.

Server computing device 130 includes demographic data 132 and data analysis program 134. Demographic data 132 includes activity information on buying habits of American consumers, including data on expenditures, income, and other consumer characteristics, for example, age, marital status, region, education and race. Demographic data 132 includes anticipated activity and expected spending activity data for a consumer, based on the consumer's demographics. Demographic data 132 can take into account reasons for changing consumer preferences, such as moving, educational advancement, property ownership changes, change in family size, occupational transitions, age, car ownership, and other changes that shift an individual's descriptive demographic profile. In an exemplary embodiment, demographic data 132 includes demographic information from the Consumer Expenditure (CE) Survey conducted by the Bureau of Labor and Statistics for the U.S. Census Bureau. Demographic data 132 can be updated using the Bureau of Labor and Statistics data yearly.

Data analysis program 134 develops an individualized program, including a rewards program, based on the interaction between data from each data source and the context derived from a consumer's activity data. Data analysis program 134 retrieves consumer activity data from various sources of data, including each of three sources of data, transactional data 122, demographic data 132, and social media data 124, and determines, based on analysis of the data, any of several categories in which the consumer is most likely to spend in order to create and adjust the rewards program for the consumer. A category, or merchant category, is a designation of a particular merchant that defines the type of goods or services provided by the merchant. Merchant categories may include, for example, grocery, fuel, retail, restaurant, drug store, or transportation. Consumer activity data includes historical transactional data, anticipated data based on demographics, and historical and anticipated data based on social media activity. Data analysis program 134 identifies consumer activity in various merchant categories based on transactional data 122 and demographic data 132. Data analysis program 134 predicts activity for a consumer in merchant categories based on social media data 124, and uses the predicted activity, in addition to the historical and anticipated data, to rank merchant categories in which the consumer spends and may spend, and creates and adjusts a rewards program for the consumer. Consumer activity data can include seasonal trends in spending, including changes in spending based on weather for example, buying warm weather clothing in winter, or changes to specific individual habits, such as vacations at a particular time of year. Consumer activity data can include changing location, for example, a move from an urban to a rural area, and changing consumer preferences, for example, an increase in fuel purchases due to the move.

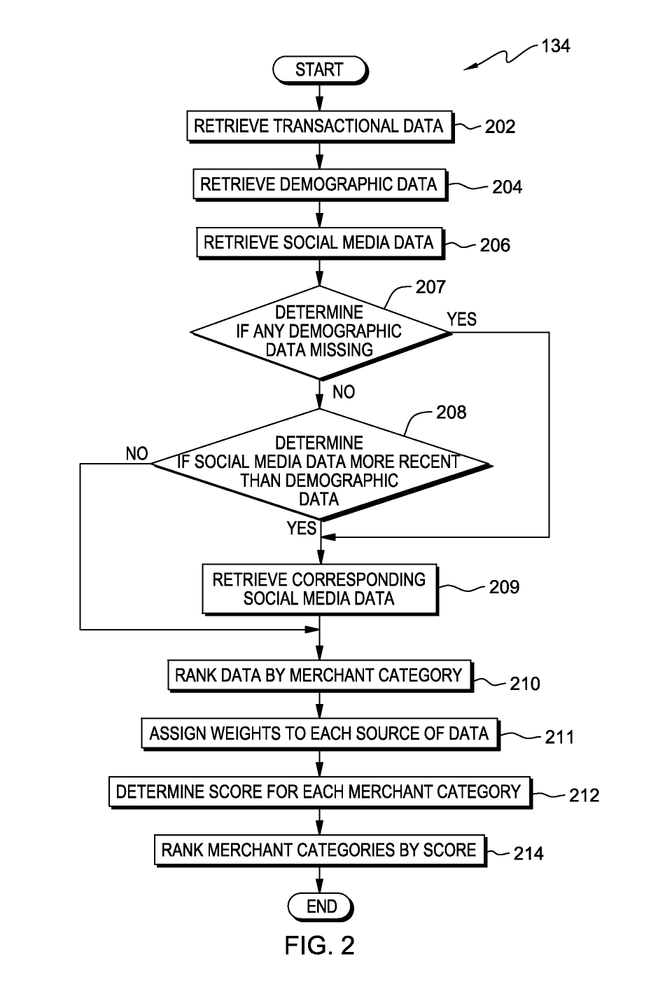

FIG. 2 is a flowchart depicting operational steps of data analysis program 134, for analyzing various data sources to determine consumer activity, in accordance with an embodiment of the present invention.

Data analysis program 134 retrieves transactional data (step 202). In an exemplary embodiment, transactional data 122 stores a consumer's historical transaction data in a structured database and receives the transaction data information from the consumer's monthly statements. The monthly statement information can contain a transaction date, amount, vendor, and a predetermined merchant category for each transaction. Each credit card company identifies transactions according to a merchant category code, which indicates the type of transaction or purchase, such as a grocery transaction or a fuel transaction. Data analysis program 134 retrieves a time period of data, for example, six months of data, and determines a transactional value by merchant category. In an alternate embodiment, in an absence of transactional data due to a lack of consumer history, data analysis program 134 does not use transactional data initially.

Data analysis program 134 retrieves demographic data (step 204). In an exemplary embodiment, demographic data 134 includes a percentage of consumer expenditure in various merchant categories, and is organized into consumer demographic attributes, such as, age, region, gender, income, size of household, urban area, education, and housing status, as several examples. Demographic data 134 anticipates consumer activity for a consumer based on the consumer's demographics. Data analysis program 134 retrieves demographic data and determines a variance between the percentage of expenses by each demographic attribute in a specific merchant category, for example, grocery store expenditures by age, and an overall percentage of expenses for the specific merchant category.

Data analysis program 134 retrieves social media data (step 206). In an exemplary embodiment, social media data 124 stores check-in data from location based applications and extracts a location and a merchant category from the check-in information. Social media data 124 can enhance a consumer's individual activity data by capturing status updates, including vacation plans and other upcoming events, likes, comments, reviews, friend activity, relationship status, life events, and other social media and social network capabilities. Additionally, popular trends on social media, either within the consumer's social network or the consumer's location, can influence the consumer's purchases in various merchant categories, for example, a new version of a phone may increase the consumer purchases of music. Social media data 124 is retrieved only from trusted and verified social media sites.

Data analysis program 134 determines if any demographic data points are missing in demographic data 134 (decision block 207). If demographic data 134 is incomplete and there are data points missing, for example, age, region, family status, gender, or race (decision block 207, “yes” branch), data analysis program 134 retrieves corresponding social media data for the incomplete data (step 209). Social media data 124 can be used to extract information about the consumer in order to enhance or influence demographic data 134. If demographic data 134 is complete (decision block 207, “no” branch), data analysis program 134 determines if social media data 124 is more recent than demographic data 134 (decision block 208).

If social media data 124 has been updated more recently than demographic data (decision block 208, “yes” branch), data analysis program retrieves corresponding social media data for the recently updated information (step 209). Social media data that overlaps with demographic attributes is retrieved, such as age, region, family status, gender, race, life events, relationship status information, education, city of residence, or any other information found in a user's social media profile. For example, if social media indicates a change in residential location from rural to urban, the demographic data input changes from rural to urban, associating the consumer with an urban consumption pattern. Additionally, social media data can be obtained using known text sentiment analysis methods, for example, a status update such as “I'm moving to California!” indicates a move to California. Data analysis program 134 uses the information from the recently updated status to enhance the demographic data regarding the consumer's region.

If social media data is not more recent than demographic data (decision block 208, “no” branch), data analysis program 134 ranks data within each source of data by merchant category (step 210). Data analysis program 134 determines merchant categories represented by data in each data source. The data is ranked to provide the top merchant categories within each data source, for example, in an exemplary embodiment, the top four merchant categories are ranked. In various embodiments of the present invention, a tie-breaker algorithm may be used if multiple merchant categories have the same rank for any given individual. Using transactional data, for example, the activity data for a consumer in each merchant category for six months is ranked by percentage of the six month total expense. In an exemplary embodiment, the rankings are refreshed every time period, for example, every six months. With respect to social media data, consumer activity can be measured using the check-in activity of the consumer at a location, and identifying the top four merchant categories at the given location. Rankings for social media data are refreshed every time period, based on new data collected.

Ranking demographic data includes calculating the overall percentage of expenses for a specific merchant category, and determining a variance between the overall percentage of expenses and the percentage of expenses for a demographic attribute. For example, an overall percentage of expenses of 5.3% may be calculated for a grocery merchant category for a time period. For demographic attribute B, e.g., age, the percentage of grocery expenses may be 4.1%, for example, a 30 year old spends 4.1% of their income on groceries. The variance determined is then −1.2% for the demographic attribute B for the merchant category grocery, indicating a 30 year old spends 1.2% less than the average. The variance is assigned an incremental weight, for example, 1.2 for the previous example. In various embodiments of the present invention, the weights are capped to factor in outliers and to ensure the weights are not skewed to avoid misrepresentation of data. The weights for each demographic attribute, e.g., age, gender, housing status, within a specific merchant category are summed to create a raw score for the merchant category, representing the statistical propensity of an individual consumer to spend more than average in that category given their demographic traits. Data analysis program 134 ranks the top four merchant categories based on the determined raw scores for each merchant category, and the ranking provides anticipated spending for the consumer based on the consumer's demographics.

Data analysis program 134 assigns weights to each source of data (step 211). Weights are assigned based on a level of accuracy and scope of the information retrieved from each data source, as compared to the data retrieved from the other data sources. As such, transactional data, based on actual historical information, is weighted the highest, demographic data, based on generalized standards, is weighted second highest, and social media data, based, for example, on check-in location inferences, is weighted the least.

Data analysis program 134 determines an individualized score for each merchant category (step 212). Data analysis program 134 derives f(x) for each merchant category according to the following equation using the data from each data source, where f(x) represents the final score for each merchant category for the individual consumer.

f(x)=α(transactional)+β(demographic)+γ(social media)

In the above, α, β, and γ are the weights assigned to each source of data, and γ<β<α. Data analysis program 134 calculates the individualized score for the consumer by multiplying each of the assigned weights by the merchant category score within each data source, for example, the historical transactional percentage of expenditure by the consumer for the grocery store merchant category and adding, for each merchant category, each of the determined scores for each data source. In an embodiment, a merchant category score within a social media data source is determined by analyzing and predicting a frequency score for the consumer, which may include, for example, how much the consumer spends, how often the consumer visits a certain location containing specific merchant categories, how often the consumer visits a certain merchant, or how often the consumer may visit a certain merchant based on, for example, a relationship status change to engaged from single.

Data analysis program 134 ranks merchant categories by score (step 214). The scores obtained by deriving f(x) for each merchant category are used to rank each merchant category and provide the top four merchant categories for the consumer, the ranking representing the consumer's historical and anticipated spending activity. The top four merchant categories can be used for targeted marketing to generate a customized rewards program for the consumer or to identify an existing rewards program for the consumer. Over pre-determined time periods, data analysis program 134 adjusts and generates merchant category rankings for the consumer in order to dynamically offer varying reward program structures with a same credit card.

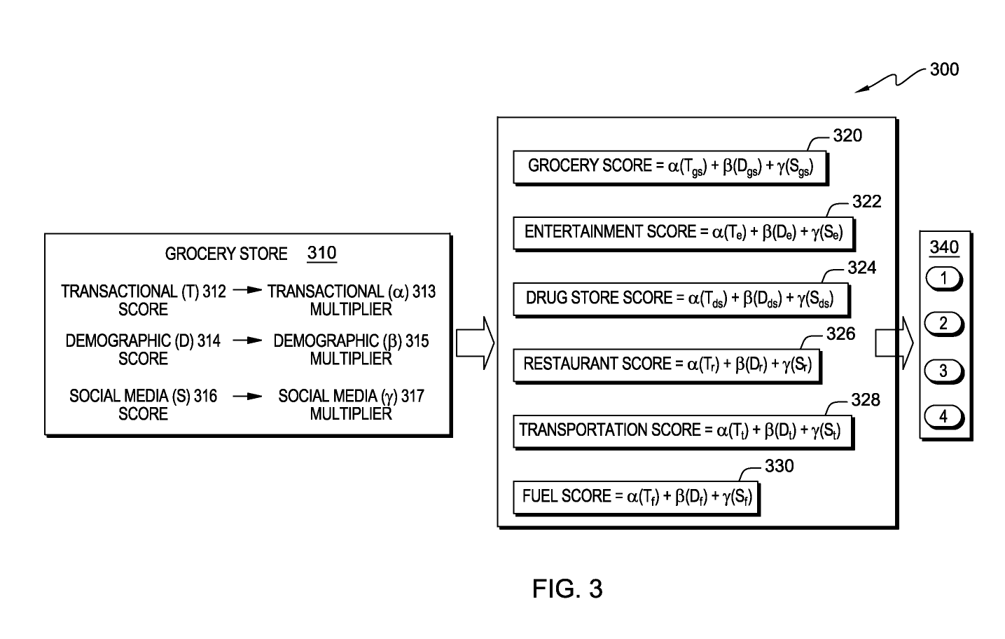

FIG. 3 illustrates an exemplary flow diagram 300 of the operational steps of data analysis program 134 using retrieved data, in accordance with an exemplary embodiment of the present invention.

Data 310 displays, for a grocery store merchant category, each source of data and the source multiplier, for example, transactional score 312 and transactional multiplier 313, demographic score 314 and demographic multiplier 315, and social media score 316 and social media multiplier 317. The data for equation 320 comes from data 310, and is used to determine the merchant category score for the grocery store category, according to equation 320.

Grocery store equation 320 and corresponding equations 322 to 330, use transactional scores (T_{gs}) determined from historical data and transactional multipliers (α), demographic scores (D_{gs}) determined using a consumer's demographics and demographic multipliers (β), and social media scores (S_{gs}) determined by a consumer's social media activity and social media multipliers (γ), for each of their respective merchant categories. The merchant category scores for the consumer are then ranked, and according to the exemplary embodiment, the top four merchant categories are generated, shown as ranking 340, in order to provide a consumer's predicted spending activity.

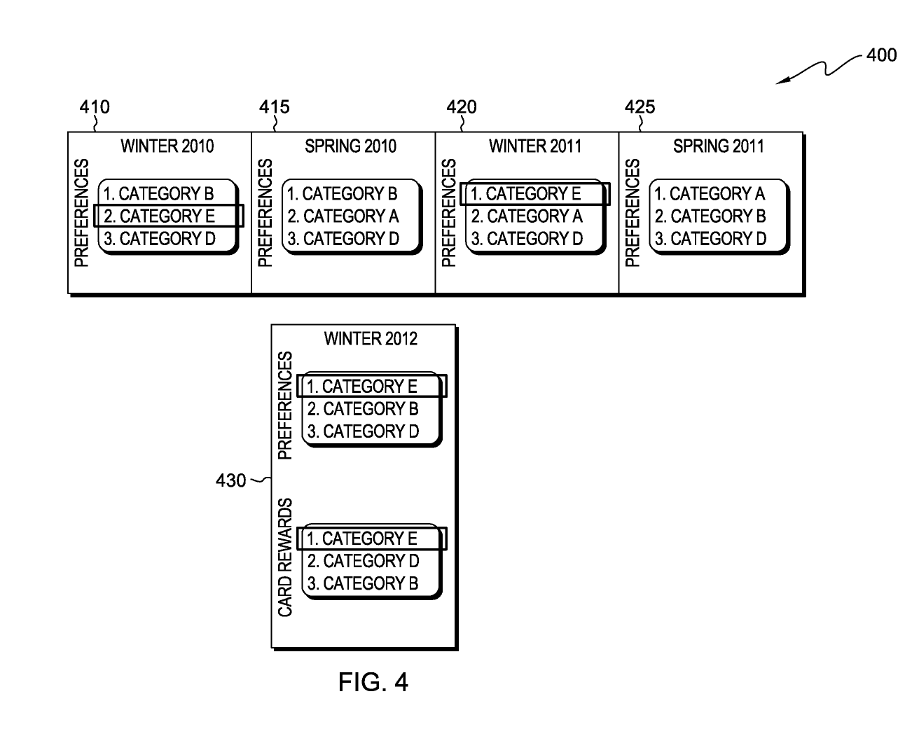

FIG. 4 illustrates an exemplary manner in which results of operation of data analysis program 134 can be used to generate a customized rewards program for a consumer, in accordance with an embodiment of the present invention.

Diagram 400 illustrates, at each time period, the ranked merchant category results obtained from data analysis program 134, shown in results 410, 415, 420, and 425. Data analysis program 134 analyzes the data to identify a consumer's activity over time, including actual spending, location, preferences, and demographics, and predict future spending activity of the consumer. In one embodiment, the top merchant category outcomes of previous seasons are analyzed by taking a three year rolling average of past results. In other embodiments, the rolling average period can be any period of years. In yet another embodiment, the ranked merchant results can be analyzed via a cognitive, semi-supervised machine learning program to capture discrete and non-discrete trends in consumer spending activity such as seasonal propensities and habits. As shown in results 410 and results 420, the consumer is highly active within merchant category E during the winter, and not during the spring, as seen in results 415 and results 425. This analysis can be used to predict a consumer's activity for the next winter, incorporating seasonal preferences, shown in prediction 430, of a higher spending in merchant category E, and to customize a consumer's rewards program for the next winter season.

FIG. 5 depicts a block diagram of components of server computing device 130 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Server computing device 130 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Data analysis program 134 can be stored in persistent storage 508 for execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 408.

Communications unit 510, in these examples, provides for communications with other data processing systems or devices, including consumer computing device 120. In these examples, communications unit 510 includes one or more network interface cards. Communications unit 510 may provide communications through the use of either or both physical and wireless communications links. Data analysis program 134 may be downloaded to persistent storage 508 through communications unit 510.

I/O interface(s) 512 allows for input and output of data with other devices that may be connected to server computing device 130. For example, I/O interface(s) 512 may provide a connection to external device(s) 518 such as a keyboard, keypad, a touch screen, and/or some other suitable input device. External device(s) 518 can also include portable computer-readable storage media such as, for example, thumb drives, portable optical or magnetic disks, and memory cards. Software and data used to practice embodiments of the present invention, e.g., data analysis program 134, can be stored on such portable computer-readable storage media and can be loaded onto persistent storage 508 via I/O interface(s) 512. I/O interface(s) 512 also connect to a display 520. Display 520 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining consumer activity, the method comprising:
a computer retrieving consumer activity data for a consumer from three data sources for a consumer, the three data sources including transactional data, demographic data, and social media data;
the computer determining, for each of the three data sources, a plurality of categories, based, at least in part, on the consumer activity data, wherein a category is a designation of a merchant of a type of good or service provided by the merchant;
the computer ranking the plurality of categories within each of the three data sources for the consumer, the ranking representing consumer activity in each category in each of the three data sources;
the computer assigning a weight to each of the three data sources for the consumer, the weight indicating a level of accuracy of the consumer activity data in each of the three data sources for the consumer as compared to the consumer activity data in the other data sources;
the computer calculating, based, at least in part, on the assigned weight and the consumer activity data for each of the three data sources, a score for each of the plurality of categories in each of the three data sources for the consumer;
the computer adding the scores for each of the plurality of categories in each of the three data sources for the consumer;
and
the computer ranking the plurality of categories for the consumer, the ranking representing the consumer activity in each of the plurality of categories.

2. The method of claim 1, further comprising:
the computer generating, based, at least in part, on the ranked plurality of categories, a rewards program for the consumer.

3. The method of claim 1, further comprising:
the computer predicting, based, at least in part, on the ranked plurality of categories and the consumer activity data from the three data sources, future spending activity of the consumer.

4. The method of claim 3, further comprising:
the computer generating, based, at least in part, on the predicted future spending activity of the consumer, a rewards program for the consumer.

5. The method of claim 1, wherein the computer retrieving consumer activity data for a consumer from three data sources further comprises:
the computer retrieving historical consumer activity data from the transactional data source, the historical consumer activity data including actual transactions made by the consumer;
the computer retrieving anticipated consumer activity data from the demographic data source, the anticipated consumer activity data including spending activity expected based on demographics of the consumer; and
the computer retrieving real-time consumer activity data from the social media data source, the real-time consumer activity data including at least a location of the consumer.

6. The method of claim 1, wherein the computer calculating a score for one of the plurality of categories in one of the three data sources further comprises:
the computer retrieving historical consumer activity data from the transactional data source, the historical consumer activity data including actual transactions made by the consumer;
the computer determining, for the one of the plurality of categories, a historical percentage of expenditure in the category based on the historical consumer activity data; and
the computer multiplying, for the one of the plurality of categories, the historical percentage of expenditure by an assigned weight corresponding to the transactional data source, the assigned weight indicating a level of accuracy of the transactional data source.

7. The method of claim 1, wherein the computer calculating a score for one of the plurality of categories in one of the three data sources further comprises:
the computer retrieving anticipated consumer activity data from the demographic data source, the anticipated consumer activity data including expected consumer spending activity based on demographics of the consumer;
the computer determining, for the one of the plurality of categories, an anticipated percentage of expenditure in the category based on the anticipated consumer activity data; and
the computer multiplying, for the one of the plurality of categories, the anticipated percentage of expenditure by an assigned weight corresponding to the demographic data source, the assigned weight indicating a level of accuracy of the demographic data source.

8. The method of claim 1, wherein the computer calculating a score for one of the plurality of categories in one of the three data sources further comprises:
the computer retrieving real-time consumer activity data from the social media data source, the real-time consumer activity data including at least a location of a consumer;
the computer determining, for the one of the plurality of categories, a frequency score for the consumer at the one of the plurality of categories; and
the computer multiplying, for the one of the plurality of categories, the frequency score by an assigned weight corresponding to the social media data source, the assigned weight indicating a level of accuracy of the social media data source.

9. A computer program product for determining consumer activity, the computer program product comprising:
one or more computer readable storage media and program instructions stored on the one or more computer readable storage media, the program instructions comprising:
program instructions to retrieve consumer activity data for a consumer from three data sources for a consumer, the three data sources including transactional data, demographic data, and social media data;
program instructions to determine, for each of the at least three data sources, a plurality of categories, based, at least in part, on the consumer activity data, wherein a category is a designation of a merchant of a type of good or service provided by the merchant;
program instructions to rank the plurality of categories within each of the three data sources for the consumer, the ranking representing consumer activity in each category in each of the three data sources;
program instructions to assign a weight to each of the at least three data sources for the consumer, the weight indicating a level of accuracy of the consumer activity data in each of the three data sources for the consumer as compared to the consumer activity data in the other data sources;
program instructions to calculate, based, at least in part, on the assigned weight and the consumer activity data for each of the three data sources, a score for each of the plurality of categories in each of the three data sources for the consumer;
program instructions to add the scores for each of the plurality of categories in each of the three data sources for the consumer; and
program instructions to rank the plurality of categories for the consumer, the ranking representing the consumer activity in each of the plurality of categories.

10. The computer program product of claim 9, further comprising:
program instructions to generate, based, at least in part, on the ranked plurality of categories, a rewards program for the consumer.

11. The computer program product of claim 9, further comprising:
program instructions to predict, based, at least in part, on the ranked plurality of categories and the consumer activity data from the three data sources, future spending activity of the consumer.

12. The computer program product of claim 11, further comprising:
program instructions to generate, based, at least in part, on the predicted future spending activity of the consumer, a rewards program for the consumer.

13. The computer program product of claim 9, wherein the program instructions to retrieve consumer activity data for a consumer from three data sources further comprise:
program instructions to retrieve historical consumer activity data from the transactional data source, the historical consumer activity data including actual transactions made by the consumer;
program instructions to retrieve anticipated consumer activity data from the demographic data source, the anticipated consumer activity data including spending activity expected based on demographics of the consumer; and
program instructions to retrieve real-time consumer activity data from the social media data source, the real-time consumer activity data including at least a location of the consumer.

14. The computer program product of claim 9, wherein the program instructions to calculate a score for one of the plurality of categories in one of the three data sources further comprise:
program instructions to retrieve historical consumer activity data from the transactional data source, the historical consumer activity data including actual transactions made by the consumer;
program instructions to determine, for the one of the plurality of categories, a historical percentage of expenditure in the category based on the historical consumer activity data; and
program instructions to multiply, for the one of the plurality of categories, the historical percentage of expenditure by an assigned weight corresponding to the transactional data source, the assigned weight indicating a level of accuracy of the transactional data source.

15. A computer system for determining consumer spending behavior, the computer system comprising:
one or more computer processors;
one or more computer-readable storage media;
program instructions stored on the computer-readable storage media for execution by at least one of the one or more processors, the program instructions comprising:
program instructions to retrieve consumer activity data for a consumer from three data sources for a consumer, the three data sources including transactional data, demographic data, and social media data;
program instructions to determine, for each of the at least three data sources, a plurality of categories, based, at least in part, on the consumer activity data, wherein a category is a designation of a merchant of a type of good or service provided by the merchant;
program instructions to rank the plurality of categories within each of the three data sources for the consumer, the ranking representing consumer activity in each category in each of the three data sources;
program instructions to assign a weight to each of the at least three data sources for the consumer, the weight indicating a level of accuracy of the consumer activity data in each of the three data sources for the consumer as compared to the consumer activity data in the other data sources;
program instructions to calculate, based, at least in part, on the assigned weight and the consumer activity data for each of the three data sources, a score for each of the plurality of categories in each of the three data sources for the consumer;
program instructions to add the scores for each of the plurality of categories in each of the three data sources for the consumer;
and
program instructions to rank the plurality of categories for the consumer, the ranking representing the consumer activity in each of the plurality of categories.

16. The computer system of claim 15, further comprising:
program instructions to generate, based, at least in part, on the ranked plurality of categories, a rewards program for the consumer.

17. The computer system of claim 15, further comprising:
program instructions to predict, based, at least in part, on the ranked plurality of categories and the consumer activity data from the three data sources, future spending activity of the consumer.

18. The computer system of claim 17, further comprising:
program instructions to generate, based, at least in part, on the predicted future spending activity of the consumer, a rewards program for the consumer.

19. The computer system of claim 15, wherein the program instructions to retrieve consumer activity data for a consumer from three data sources further comprise:
program instructions to retrieve historical consumer activity data from the transactional data source, the historical consumer activity data including actual transactions made by the consumer;
program instructions to retrieve anticipated consumer activity data from the demographic data source, the anticipated consumer activity data including spending activity expected based on demographics of the consumer; and
program instructions to retrieve real-time consumer activity data from the social media data source, the real-time consumer activity data including at least a location of the consumer.

20. The computer system of claim 15, wherein the program instructions to calculate a score for one of the plurality of categories in one of the three data sources further comprise:
program instructions to retrieve historical consumer activity data from the transactional data source, the historical consumer activity data including actual transactions made by the consumer;
program instructions to determine, for the one of the plurality of categories, a historical percentage of expenditure in the category based on the historical consumer activity data; and
program instructions to multiply, for the one of the plurality of categories, the historical percentage of expenditure by an assigned weight corresponding to the transactional data source, the assigned weight indicating a level of accuracy of the transactional data source.
